(19) United States
(12) Patent Application Publication
(10) Pub. No.: US 2001/0029239 A1
(43) Pub. Date: Oct. 11, 2001

(54) New herbicidal compositions

(76) Inventors: Michael Colin Cramp, Essex (GB); Stephen Robert Mack, Stapleford (GB); Michael Gingell, Essex (GB)

Correspondence Address: Connolly Bove Lodge & Hutz LLP, P. O. BOX 2207, Wilmington, DE, 19899-2207, US

(21) Appl. No.: 09/741,707

(22) Filed: Dec. 20, 2000

(30) Foreign Application Priority Data
Dec. 24, 1999 (GB) 99 30703-5

(51) Int. Cl. A01N 55/10; A01N 43/54; A01N 43/66; C07F 7/04; C07F 7/08

(52) U.S. Cl. 504/227; 504/193; 504/242; 504/317; 544/315; 544/216; 544/229; 556/437; 560/55

(57) ABSTRACT

The invention relates to aryl vinyl ether compounds of formula (I):

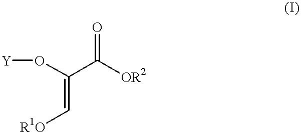

wherein R¹, R² and Y are as defined in the description; to compositions containing them, processes and intermediates for their preparation and a method of controlling weeds by means of such compositions.

### BACKGROUND OF THE INVENTION

The invention relates to novel aryl vinyl ethers having herbicidal properties, compositions containing them, processes and intermediates for their preparation and a method of controlling weeds by means of such compositions.

An object of this invention is to provide new aryl vinyl ether derivatives useful as highly effective herbicides, and processes for their preparation.

Another object of the instant invention is to provide herbicides which are effective against grasses in addition to broad-leafed weeds.

Another object is to provide herbicides which possess selective herbicidal activity.

Another object is to provide herbicides effective as low dose herbicides.

These and other objects of the instant invention can be achieved in whole or in part by means of the compounds of the invention.

### DESCRIPTION OF THE INVENTION

The present invention provides a compound which is an aryl vinyl ether of formula (I):

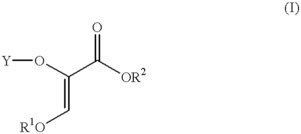

wherein;

R¹ and R², which are the same or different, each independently represent a hydrogen atom, alkyl, alkenyl, alkynyl or —(CH₂)ₘ-phenyl;

Y represents a group of formula (A) or (B);

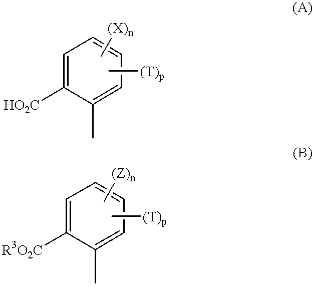

X represents —CH₂OCOR⁴, —CH₂S(O)_{q}R⁵—CH₂S(O)_{q}R¹⁶, —CH₂CN, —CH₂CO₂R⁶, —CH₂OR⁷ or a group Z;

Z represents —OC(CO₂R⁸)═CHOR⁹, —OR¹⁰, —CH2NHCOR¹¹, —CH₂SCOR¹², —CH₂OC(═S)R¹², —CH₂SC(═S)R¹², —S(O)ₜR¹⁵, —CH₂CH₂R¹⁶, —CH₂SO₂NR^{a}R^{b}, —CH₂OR¹⁶, —OCH₂R¹⁶, or a group of formula (C);

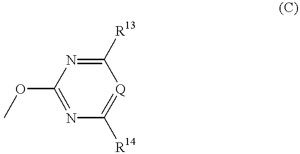

R³ represents alkyl, haloalkyl, alkenyl, haloalkenyl, alkynyl, haloalkynyl or —CH₂COR¹⁶;

R⁴ represents alkyl, haloalkyl, alkenyl, haloalkenyl, alkynyl, haloalkynyl, cycloalkyl, cycloalkylalkyl or —(CH₂)ₛR¹⁶;

R⁵, R⁶, R⁷, R¹¹ and R¹², which are the same or different, independently represent alkyl or haloalkyl;

R⁸ is as defined for R²;

R⁹ is as defined for R¹;

R¹⁰ represents alkenyl, alkynyl, cycloalkyl; or an alkyl or haloalkyl group which is substituted by a group selected from alkoxy, haloalkoxy, alkoxycarbonyl, cyano, carbamoyl, alkylcarbamoyl, dialkylcarbamoyl and R¹⁶;

R³ and R¹⁴, which are the same or different, each independently represent alkyl or alkoxy;

R¹⁵ represents R¹⁰ or R¹⁶;

R¹⁶ represents phenyl unsubstituted or substituted by halogen, alkyl, haloalkyl, —S(O)ᵣR¹⁷, cyano, nitro, alkoxy or haloalkoxy;

R^{a} and R^{b}, which are the same or different, each independently represent hydrogen, alkyl or haloalkyl;

Q represents CH or N;

T represents a halogen atom, hydroxy, cyano, alkoxycarbonyl, alkyl, haloalkyl, alkenyl, haloalkenyl, alkynyl, haloalkynyl, cycloalkyl, alkoxy, haloalkoxy, haloalkoxycarbonyl, nitro, amino, alkylamino, dialkylamino, phenoxy, alkylcarbonylamino, carbamoyl, alkylcarbamoyl, dialkylcarbamoyl or —S(O)ᵣR¹⁷;

R¹⁷ represents alkyl, haloalkyl, alkenyl or haloalkenyl;

m and s represent zero or one;

n represents one or two;

p represents zero, one, two or three;

q, r and t represent zero, one or two;

or an agriculturally acceptable salt or metal complex thereof, which has valuable herbicidal properties.

The invention is also directed to any stereoisomer, enantiomer, geometric isomer or mixture thereof. The aryl vinyl ether derivatives of the present invention have two possible stereoisomers, (Z) and (E) isomers, as defined in the Cahn-Ingold-Prelog rules at a double bond. It will be understood that the present invention embraces both the pure isomers and more or less enriched mixtures thereof. Furthermore it is understood that the compounds of formula (I) wherein R² and Y are as defined above and R¹ is hydrogen may exist in a tautomeric form or an acetal form.

By the term “agriculturally acceptable salts” is meant salts the cations or anions of which are known and accepted in the art for the formation of salts for agricultural or horticultural use. Suitable salts with bases include alkali metal (e.g. sodium and potassium), alkaline earth metal (e.g. calcium and magnesium), ammonium and amine (e.g. diethanolamine, triethanolamine, octylamine, morpholine and dioctylmethylamine) salts. Suitable acid addition salts, e.g. formed by compounds of formula I containing an amino group, include salts with inorganic acids, for example hydrochlorides, sulphates, phosphates and nitrates and salts with organic acids for example acetic acid.

In the present patent specification, including the accompanying claims, the aforementioned substituents have the following meanings:

halogen atom means fluorine, chlorine, bromine or iodine;

alkyl groups and portions thereof may be straight- or branched-chain and contain from one to six carbon atoms;

alkenyl and alkynyl groups and portions thereof may be straight- or branched-chain and contain from two to six carbon atoms;

cycloalkyl groups have from three to six carbon atoms in the ring and may be substituted by alkyl or halogen.

Preferred compounds of formula (I) above include those in which:

R¹ and R², which are the same or different each independently represent a hydrogen atom, alkyl, alkenyl, alkynyl or —(CH₂)ₘ-phenyl;

Y represents a group of formula (A) or (B);

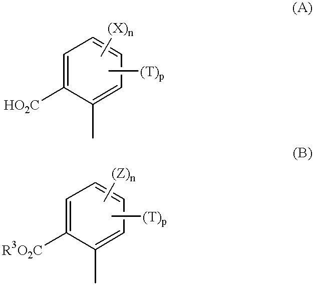

X represents —CH₂OCOR⁴, —CH₂S(O)_{q}R⁵, —CH₂CN, —CH₂CO₂R⁶, —CH₂OR⁷ or a group Z;

Z represents —OC(CO₂R⁸) CHOR⁹, —OR¹⁰, 13 CH₂NHCOR¹¹, —CH₂SCOR¹², —CH₂OC(═S)R¹², —CH₂SC(═S)R¹², —S(O)ₜR¹⁵, or a group of formula (C);

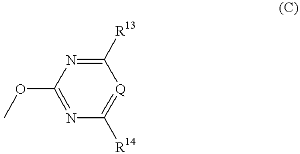

R³ represents alkyl, haloalkyl, alkenyl, haloalkenyl, alkynyl, haloalkynyl or —CH₂COR¹⁶;

R⁴ represents alkyl, haloalkyl, alkenyl, haloalkenyl, alkynyl, haloalkynyl, cycloalkyl, cycloalkylalkyl or —(CH₂)ₛR¹⁶;

R⁵, R⁶, R⁷, R¹¹ and R¹², which are the same or different, independently represent alkyl or haloalkyl;

R⁸ is as defined for R²;

R⁹ is as defined for R¹;

R¹⁰ represents alkenyl, alkynyl, cycloalkyl; or an alkyl or haloalkyl group which is substituted by a group selected from alkoxy, haloalkoxy, alkoxycarbonyl, cyano, carbamoyl, alkylcarbamoyl, dialkylcarbamoyl and R¹⁶;

R¹³ and R¹⁴, which are the same or different, each independently represent alkyl or alkoxy;

R¹⁵ represents R¹⁰ or R¹⁶;

R¹⁶ represents phenyl unsubstituted or substituted by halogen, alkyl, haloalkyl, —S(O)ᵣR¹⁷, cyano, nitro, alkoxy or haloalkoxy;

Q represents CH or N;

T represents a halogen atom, hydroxy, cyano, alkoxycarbonyl, alkyl, haloalkyl, alkenyl, haloalkenyl, alkynyl, haloalkynyl, cycloalkyl, alkoxy, haloalkoxy, haloalkoxycarbonyl, nitro, amino, alkylamino, dialkylamino, phenoxy, alkylcarbonylamino, carbamoyl, alkylcarbamoyl, dialkylcarbamoyl or —S(O)ᵣR¹⁷;

R¹⁷ represents alkyl, haloalkyl, alkenyl or haloalkenyl;

m and s represent zero or one;

n represents one or two;

p represents zero, one, two or three;

q, r and t represent zero, one or two;

Compounds of formula (I) in which R¹ represents hydrogen, alkyl or propargyl are preferred (more preferably R¹ represents alkyl or propargyl, most preferably R¹ represents methyl or propargyl).

Compounds of formula (I) in which R² represents alkyl are preferred (more preferably R² represents methyl).

Compounds in which one X group is present which is located ortho to the CO₂H group (when Y is a group of formula (A)), or one Z group is present which is located ortho to CO₂R³ (when Y is a group of formula (B)) are also preferred.

Preferred compounds are also those in which Y represents a group of formula (A) and X represents —CH₂OCOR⁴; —CH₂S(O)_{q}R⁵; —CH₂OR⁷; —OC(CO₂R⁸)═CHOR⁹; —CH₂S(O)_{q}R¹⁶ where R¹⁶ is phenyl; —S(O)ₜR¹⁵ where R¹⁵ is phenyl; —CH₂OR¹⁶ where R¹⁶ is phenyl optionally substituted by halogen, CN, alkoxy or alkyl; —OCH₂R¹⁶ where R¹⁶ is phenyl optionally substituted by halogen; or a group of formula (C);

R⁴ represents alkyl or —(CH₂)ₛR¹⁶ where R¹⁶ represents phenyl;

R⁵, R⁷, R⁸ and R⁹each represent alkyl;

R¹³ and R¹⁴ represent methyl or methoxy; and

Q represents CH.

Preferred compounds are also those in which Y represents a group of formula (B) and

Z represents —OC(CO₂R⁸)═CHOR⁹; —S(O)ₜR¹⁵ where R¹⁵ is phenyl; —CH₂OR¹⁶ where R¹⁶ is phenyl optionally substituted by halogen, CN, alkoxy or alkyl; or a group of formula (C);

R⁸ and R⁹ each represent alkyl;

R¹³ and R¹⁴ represent methyl or methoxy; and

Q represents CH.

Compounds in which T represents halogen or alkyl and p is 0 or 1 are also preferred.

A preferred class of compounds are those in which:

R¹ represents hydrogen, methyl or propargyl;

R² represents methyl;

Y represents a group of formula (A);

X represents —CH₂OCOR⁴; —CH₂S(O)_{q}R⁵; —CH₂OR⁷; —OC(CO₂R⁸)═CHOR⁹; —CH₂S(O)_{q}R¹⁶ where R¹⁶ is phenyl; —CH₂OR¹⁶ where R¹⁶ is phenyl optionally substituted by halogen, CN, alkoxy or alkyl; —OCH₂R¹⁶ where R¹⁶ is phenyl optionally substituted by halogen; or a group of formula (C);

R⁴ represents alkyl or —(CH₂)ₛR¹⁶ where R¹⁶ represents phenyl;

R⁵, R⁷, R⁸ and R⁹ each represent alkyl;

R¹³ and R¹⁴ represent methyl or methoxy;

Q represents CH; and

T represents halogen or alkyl.

A further preferred class of compounds are those in which:

R¹ represents methyl or propargyl; R² represents methyl; Y represents a group of formula (B) and Z represents —OC(CO₂R⁸)═CHOR⁹; —CH₂OR¹⁸ where R¹⁶ is phenyl optionally substituted by halogen, CN, alkoxy or alkyl; or a group of formula (C);

R⁴ represents alkyl or —(CH₂)ₛR¹⁶ where R¹⁶ represents phenyl;

R⁸ and R⁹ each represent alkyl;

R¹³ and R¹⁴ represent methyl or methoxy;

Q represents CH; and

T represents halogen or alkyl.

The following compounds are particularly preferred:

2,6-bis(2-methoxy-1-methoxycarbonyl-vinyloxy)benzoic acid (compound 1);

methyl 2-(3-acetoxymethyl-2-carboxyphenoxy)-3-methoxypropenoate (compound 2);

methyl 2-(2-carboxy-3-methylthiomethylphenoxy)-3-methoxypropenoate (compound 3);

methyl 2-(3-acetoxymethyl-2-carboxy-4-fluorophenoxy)-3-methoxypropenoate (compound 4);

methyl 2-(3-benzoyloxymethyl-2-carboxy-4-fluorophenoxy)-3-methoxypropenoate (compound 5);

methyl 2-(3-acetoxymethyl-2-carboxy-4-chlorophenoxy)-3-methoxypropenoate (compound 6);

methyl 2-(2-carboxy-3-phenylacetyloxyrethyl-4-fluorophenoxy)-3-nethoxypropenoate (compound 7);

methyl 2-(4-acetoxymethyl-2-carboxy-3-methylphenoxy)-3-methoxypropenoate (compound 8);

methyl 2-[2-carboxy-3-(4,6-dimethoxypyrimidin-2-yl)oxyphenoxy]-3-methoxypropenoate (compound 9);

methyl 2-(2-carboxy-4-chloro-3-methylthiomethylphenoxy)-3-methoxypropenoate (compound 10);

tert butyl 2,6-bis(2-methoxy-1-methoxycarbonyl-vinyloxy)benzoate (compound 11);

methyl 2-[2-tert-butoxycarbonyl-3-(4,6-dimethoxypyrimidin-2-yl)oxyphenoxy]-3-methoxypropenoate (compound 1 2);

propargyl 2,6-bis(2-methoxy-1-methoxycarbonyl-vinyloxy)benzoate (compound 13);

benzyl 2,6-bis(2-methoxy-1-methoxycarbonyl-vinyloxy)benzoate (compound 14);

propyl 2,6-bis(2-methoxy-1-methoxycarbonyl-vinyloxy)benzoate (compound 15);

methyl 2-(2-carboxy-3-phenoxymethylphenoxy)-3-methoxypropenoate (compound 16);

methyl 2-(2-carboxy-3-(4-chlorophenoxymethyl)phenoxy)-3-methoxypropenoate (compound 17);

methyl 2-[2-carboxy-3-(4-cyanophenoxymethyl)phenoxy)-3-methoxypropenoate (compound 18);

methyl 2-[2-carboxy-3-(4-methoxyphenoxymethyl)phenoxy)-3-methoxypropenoate (compound 19);

methyl 2-[2-carboxy-3-(4-methylphenoxymethyl)phenoxy)-3-methoxypropenoate (compound 20);

methyl 2-[2-carboxy-4-fluoro-3-(phenylthiomethyl)phenoxy)-3-methoxypropenoate (compound 21);

methyl 2-[2-carboxy-3-(3-chlorobenzyloxy)phenoxy)-3-methoxypropenoate (compound 22);

methyl 2-[2-carboxy-3-(2-chlorobenzyloxy)phenoxy)-3-methoxypropenoate (compound 23);

methyl 2-[2-carboxy-3-(phenylthio)phenoxy]-3-methoxypropenoate (compound 24);

methyl 2-(2-carboxy-3-phenylsulphinylphenoxy)-3-methoxypropenoate (compound 25);

methyl 2-(2-carboxy-3-phenylsulphonylphenoxy)-3-methoxypropenoate (compound 26);

methyl 2-(2-tert-butoxycarbonyl-3-phenylthiophenoxy)-3-methoxypropenoate (compound 27);

methyl 2-(2-tert-butoxycarbonyl-3-phenylsulphinylphenoxy)-3-methoxypropenoate (compound 28);

methyl 2-(2-tert-butoxycarbonyl-3-phenylsulphonylphenoxy)-3-methoxypropenoate (compound 29);

methyl 2-[2-tert-butoxycarbonyl-3-(phenylthio)phenoxy]-3-hydroxypropenoate (compound 30);

tert butyl 2,6-bis(2-hydroxy-1-methoxycarbonyl-vinyloxy)benzoate (compound 31);

methyl 2-[2-tert-butoxycarbonyl-3-(4, 6-dimethoxypyrimidin-2-yl)oxyphenoxy]-3-hydroxypropenoate (compound 32);

methyl 2-[2-carboxy-3-(3-chlorobenzyloxy)phenoxy]-3-methoxypropenoate (compound 33);

methyl 2-[2-carboxy-3-(2-chlorobenzyloxy)phenoxy]-3-methoxypropenoate (compound 34);

methyl 2-(2-tert-butoxycarbonyl-3-phenoxymethylphenoxy)-3-methoxypropenoate (compound 35);

methyl 2-[2-tert-butoxycarbonyl-3-(4-chlorophenoxymethyl)phenoxy]-3-methoxypropenoate (compound 36);

methyl 2-[2-tert-butoxycarbonyl-3-(4-cyanophenoxymethyl)phenoxy]-3-methoxypropenoate (compound 37);

methyl 2-[2-tert-butoxycarbonyl-3-(4-methoxyphenoxymethyl)phenoxy]-3-methoxypropenoate (compound 38); and

methyl 2-[2-tert-butoxycarbonyl-3-(4-methylphenoxymethyl)phenoxy]-3-methoxypropenoate (compound 39).

The numbers 1-39 are assigned to these compounds for reference and identification hereafter.

Compounds of formula (1) above may be prepared by the application or adaptation of known methods (i.e. methods heretofore used or described in the literature), for example as hereinafter described

In the following description where symbols appearing in formulae are not specifically defined, it is to be understood that they are “as hereinbefore defined” in accordance with the first definition of each symbol in the specification.

It is to be understood that in the descriptions of the following processes the sequences may be performed in different orders, and that suitable protecting groups may be required to achieve the compounds sought.

According to a feature of the present invention, compounds of the invention wherein R¹ and R² are as defined above and Y represents a group of formula (A) may be prepared by hydrolysing a corresponding compound in which the —CO₂H group is replaced by —CO₂R³ wherein R³ is tert-butyl. The hydrolysis is generally conducted using an acid such as trifluoroacetic acid, optionally in the presence of an acid such as sulphuric acid and preferably a dehydrating agent such as anhydrous magnesium sulphate, in a solvent such as dichloromethane at a temperature of from 0-50° C. According to a further feature of the present invention compounds of the invention, wherein R² and Y are as defined above and R¹ is alkyl, alkenyl, alkynyl or —(CH₂)ₛphenyl may be prepared by alkylating a corresponding compound of formula (I) wherein R¹ is hydrogen. The alkylation is performed using a suitable alkylating agent, generally a dialkysulfate such as dimethylsulfate, or an alkyl halide, preferably an alkyl iodide such as methyl iodide. The alkylation may be performed in the absence or presence of an organic solvent, such as ether or N,N-dimethylformamide, at a temperature between 0° and 40° C., optionally in the presence of a base, such as a tertiary amine, for example triethylamine, or an alkali metal carbonate or bicarbonate, such as potassium carbonate.

According to a further feature of the present invention, compounds of the invention, wherein R² and Y are as defined above and R¹ is hydrogen, may be prepared from compounds of formula (II):

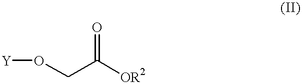

by treatment with an aminomethylating agent followed by hydrolysis with an acid. The aminomethylating agent is generally a dialkylaminodialkylacetal, such as dimethylformamide dimethyl acetal, or an alkoxybis(dialkylamino)methane, typically tert-butoxybis(dimethylamino)methane (Bredereck's reagent). The reaction may be conducted in the absence or in the presence of an organic solvent such as toluene at a temperature between 20° C. and 150° C., preferably between 80° C. and 130° C. Hydrolysis is generally accomplished using an acid, generally a mineral acid, such as hydrochloric acid in the presence of an organic solvent, which may or may not be miscible with water, such as tetrahydrofuran.

According to a further feature of the present invention compounds of the invention wherein R¹ and R² are as defined above and Y represents a group of formula (B) may be prepared by esterifiying a corresponding compound in which the —CO₂R³ group is replaced by —CO₂H, by treatment with an alcohol of formula (Ill):

R³—OH (III)

wherein R³ is as defined above. The esterification is generally carried out in the presence of an organic solvent, preferably an excess of the alcohol R³OH, optionally in the presence of an acid or base catalyst, preferably an acid catalyst such as sulphuric acid. Alternatively the esterification may be carried out using a halide of formula (IIIa):

R³—L (IIIa)

wherein L is a leaving group, generally a halogen atom, for example bromine. The reaction is generally performed in the presence of a base such as potassium carbonate, in a solvent such as acetonitrile, at a temperature of from 0° C. to the reflux temperature.

According to a further feature of the present invention, compounds of the invention wherein R¹, R² are as defined above, Y is a group of formula (A) and X is —CH₂OCOR⁴ may be prepared by treatment of the corresponding compound in which X is replaced —CH₂—L, wherein L is a leaving group, generally a sulfonate ester such as a para toluenesulfonate or a mesylate, or a halogen, preferably bromine, chlorine or iodine, with a metal salt of formula (IV):

R⁴COO⁻M⁺ (IV)

wherein R⁴ is as defined above and M is an alkali metal, and such as sodium, in an organic solvent such as N,N-dimethylformamide or dimethylacetamide, at a temperature between 0° C. and 100° C.

According to a further feature of the present invention, compounds of the invention wherein R¹, R² are as defined above, Y is a group of formula (A) and X is —CH₂OR⁷ may be prepared by treatment of the corresponding compound in which X is replaced by —CH₂—L, wherein L is a leaving group, typically as defined above, with a metal salt of formula (V):

R⁷IM (V)

wherein R⁷ is as defined above and M is an alkali metal such as sodium or lithium, in an organic solvent such as N,N-dimethylformamide, at a temperature between 0° C. and 100° C.

According to a further feature of the present invention, compounds of the invention wherein R¹ and R² are as defined above, Y is a group of formula (A), X is —CH₂S(O)_{q}R⁵ and q is zero may be prepared by thiolating a corresponding compound in which X is replaced by —CH₂—L, wherein L is a leaving group, for instance as defined above. The thiolation is generally performed using a metal salt of formula (VI):

R⁵SM (VI)

wherein R⁵ is as defined above and M is an alkali metal such as sodium or lithium, optionally in the presence of a base such as an alkali metal carbonate, for example potassium carbonate, in an organic solvent such as acetonitrile, at a temperature between 0° C. and the reflux temperature of the solvent.

According to a further feature of the present invention compounds of the invention wherein R¹ and R² are as defined above, Y is a group of formula (A), X is —CH₂S(O)_{q}R⁵ and q is one or two may be prepared by oxidising a corresponding compound in which q is zero or one. The reaction is generally performed using an oxidant such as m-chloroperbenzoic acid in a solvent such as chloroform at a temperature of from 0° C. to the reflux temperature.

According to a further feature of the present invention, compounds of the invention wherein R¹, R² are as defined above, Y is a group of formula (A) and X is —CH₂CN may be prepared by cyanating a corresponding compound in which X is replaced by —CH₂—L wherein L is a leaving group, for instance as defined above. The cyanation is generally performed using an alkali metal cyanide such as sodium or potassium cyanide, in an organic solvent such as dimethylformamide or dimethylsulfoxide, at a temperature between 0° C. and 150° C., preferably 0° to 60° C. Intermediates of formula (I) wherein R¹ and R² are as defined above, and X is replaced by —CH₂—L, where L is a halogen, may be prepared by the halogenation of the corresponding compound in which X is replaced by methyl. The reaction is generally performed using a suitable halogenating agent such as N-bromosuccinimide, N-chlorosuccinimide or N-iodosuccinimide, generally in an inert solvent such as dichloromethane, optionally with a radical initiator such as azobisisobutyronitrile, and optionally in the presence of light, at a temperature of from —80° C. to 1500C. Intermediates of formula (II) are generally known or may be prepared by the alkylation of the corresponding compound of formula (VII):

Y—OH (VII)

with a haloacetate of formula (VIII):

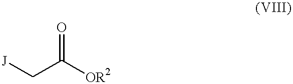

wherein J is a halogen such as bromine. The alkylation is generally performed in the presence of a base in an inert solvent at a temperature of from 30° C. to 100° C. Compounds of formula (III), (IV), (V), (VI), (VII) and (VIII) are known or may be prepared by known methods.

The following non-limiting examples illustrate the invention. MS refers to the observed molecular ion in the mass spectrum.

### EXAMPLE 1

Trifluoroacetic acid (0.57 ml) was added dropwise over 2 minutes to a solution of tert butyl 2,6-bis(2-methoxy-1-methoxycarbonyl-vinyloxy)benzoate (0.33 g) in dichloromethane at 0° C. The mixture was stirred for 2 hours at 20° C., diluted with ethyl acetate and extracted with aqueous sodium bicarbonate. The aqueous phase was acidified with sulphuric acid and extracted with ethyl acetate. The organic layer was washed (brine), dried (magnesium sulphate) and evaporated to give 2,6-bis(2-methoxy-1-methoxycarbonyl-vinyloxy)benzoic acid (compound 1, 0.25 g) MS [M+H]=383.

The following compounds were similarly prepared:

methyl 2-(3-acetoxymethyl-2-carboxyphenoxy)-3-methoxypropenoate (compound 2), NMR 2.1(s,3H), 3.2(s,3H), 4.0(s,3H), 5.4(s,2H), 6.9(d,1H), 7.2(d,1H), 7.4(t,1H), 7.4(s,1H);

methyl 2-(2-carboxy-3-methylthiomethylphenoxy)-3-methoxypropenoate (compound 3), NMR 2.0(s,3H), 3.8(s,3H), 3.9(s,2H), 4.0(s,3H), 6.8(d,1H), 7.1(d,1H), 7.3(t,1H), 7.4(s,1H);

methyl 2-(3-acetoxymethyl-2-carboxy-4-fluorophenoxy)-3-methoxypropenoate (compound 4), NMR 2.0(s,3H), 3.7(s,3H), 3.9(s,3H), 5.2(s,2H), 6.8(m,1H), 7.0(t,1H), 7.3(s,1H);

methyl 2-(3-benzoyloxymethyl-2-carboxy-4-fluorophenoxy)-3-methoxypropenoate (compound 5), NMR 3.7(s,3H), 3.9(s,3H), 5.5(s,2H), 6.9(m,1H), 7.0(t,1H), 7.2(s,1H), 7.4(d,2H), 7.5(t,1H), 8.0(d,2H);

methyl 2-(3-acetoxymethyl-2-carboxy-4-chlorophenoxy)-3-methoxypropenoate (compound 6), NMR 2.1 (s,3H), 3.8(s,3H), 4.0(s,3H), 5.4(s,2H), 6.9(d,1H), 7.4(d,1H), 7.4(s,1H);

methyl 2-(2-carboxy-3-phenylacetyloxymethyl-4-fluorophenoxy)-3-methoxypropenoate (compound 7), NMR 3.6(s,2H), 3.7(s,3H), 3.9(s,3H), 5.3(s,2H), 6.8(m,1H), 7.0(t,1H), 7.2(bm,5H), 7.3(s,1H);

methyl 2-(4-acetoxymethyl-2-carboxy-3-methylphenoxy)-3-methoxypropenoate (compound 8), NMR 1.9(s,3H), 2.4(s,3H), 3.7(s,3H), 3.9(s,3H), 5.0(s,2H), 6.7(d,1H), 7.2(d,1H), 7.3(S,1H);

methyl 2-[2-carboxy-3-(4,6-dimethoxypyrimidin-2-yl)oxyphenoxy]-3-methoxypropenoate (compound 9), NMR 3.6(s,3H), 3.7(s,6H), 3.8(s,3H), 5.6(s,1H), 6.7(d,1H), 6.8(d,1H), 7.2(t,1H), 7.2(s,1H);

methyl 2-(2-carboxy-4-chloro-3-methylthiomethylphenoxy)-3-methoxypropenoate (compound 10), NMR 2.1(s,3H), 3.7(s,3H), 3.9(s,3H), 4.0(s,2H), 6.7(d,1H), 7.3(d,1H), 7.4(s,1H);

methyl 2-[2-carboxy-3-(phenoxymethyl)phenoxy]-3-methoxypropenoate (compound 16), NMR 3.8 (s, 3H), 4.0 (s, 3H), 5.4 (s, 2H), 7.0 (m, 4H), 7.3 (m, 2H), 7.4 (m, 3H), 11.4 (br s, 1H);

methyl 2-[2-carboxy-3-(4-chlorophenoxymethyl)phenoxy]-3-methoxypropenoate (compound 17), NMR 3.7 (s, 3H), 3.9 (s, 3H), 5.2 (s, 2H), 6.8 (m, 3H), 7.2 (m, 2H), 7.3 (m, 3H);

methyl 2-[2-carboxy-3-(4-cyanophenoxymethyl)phenoxy]-3-methoxypropenoate (compound 18), NMR 3.7 (s, 3H), 3.9 (s, 3H), 5.3 (s, 2H), 6.9 (d, 1H), 7.0 (d, 2H), 7.3 (m, 3H), 7.5 (d, 2H), 11.4 (br s, 1H);

methyl 2-[2-carboxy-3-(4-methoxyphenoxymethyl)phenoxy]-3-methoxypropenoate (compound 19), NMR 3.7 (s, 3H), 3.7 (s, 3H), 3.9 (s, 3H), 5.2 (s, 2H), 6.8 (m, 5H), 7.3 (m, 3H), 11.3 (br s, 1H);

methyl 2-[2-carboxy-3-(4-methylphenoxymethyl)phenoxy]-3-methoxypropenoate (compound 20), NMR 2.2 (s, 3H), 3.7 (s, 3H), 3.9 (s, 3H), 5.2 (s, 2H), 6.8 (d, 2H), 7.0 (d, 2H), 7.3 (m, 4H), 11.3 (br s, 1H);

methyl 2-(2-carboxy-4-fluoro-3-phenylthiomethylphenoxy)-3-methoxypropenoate (compound 21), NMR 3.8 (s, 3H), 4.0 (s, 3H), 4.4 (s, 2H), 6.8 (dd, 1H), 7.0 (t, 1H), 7.3 (m, 6H);

methyl 2-[2-carboxy-3-(3-chlorobenzyloxy)phenoxy)-3-methoxypropenoate (compound 22), NMR 3.8 (s, 3H), 4.0 (s, 3H), 5.3 (s, 2H), 6.6 (d, 1H), 6.8 (d, 1H), 7.3 (m, 5H), 7.8 (d, 1H), 10.8 (br s, 1H);

methyl 2-[2-carboxy-3-(2-chlorobenzyloxy)phenoxy)-3-methoxypropenoate (compound 23), NMR 3.8 (s, 3H), 4.0 (s, 3H), 5.2 (s, 2H), 6.6 (d, 1H), 6.7 (d, 1H), 7.3 (m, 6H), 10.8 (br s, 1H);

methyl 2-[2-carboxy-3-(phenylthio)phenoxy]-3-methoxypropenoate (compound 24), NMR 3.8 (s,3H), 4.0(s,3H), 6.7(m,2H), 7.1(m,1H), 7.4(m,4H), 7.5(m,2H), 11.0(broad,1H);

methyl 2-(2-carboxy-3-phenylsulphinylphenoxy)-3-methoxypropenoate (compound 25), NMR 3.7(s,3H), 3.85(s,3H), 7.0(m,1H), 7.3(s,2H), 7.4(m,3H), 7.8(m,1H) 8.0(m,2H);

methyl 2-(2-carboxy-3-phenylsulphonylphenoxy)-3-methoxypropenoate (compound 26), NMR 3.8((s,3H), 4.0(s,3H), 7.05(m,1H), 7.4(m,3H), 7.65(m,1H), 7.85(m,3H), 8.1(m,1H);

methyl 2-[2-carboxy-3-(3-chlorobenzyloxy)phenoxy]-3-methoxypropenoate (compound 33); and

methyl 2-[2-carboxy-3-(2-chlorobenzyloxy) phenoxy]-3-methoxypropenoate (compound 34).

### EXAMPLE 2

A mixture of tert butyl 2,6-bis(2-hydroxy-1-methoxycarbonyl-vinyloxy)benzoate (0.63 g), potassium carbonate (0.85 g), dimethyl sulphate (0.43 ml) and N,N-dimethylformamide was stirred for 3.5 hours at 20° C., filtered, sodium carbonate solution added and extracted with ether. The organic layer was washed with water and brine, dried (magnesium sulphate) and evaporated to give tert butyl 2,6-bis(2-methoxy-1-methoxycarbonyl-vinyloxy)benzoate (compound 11, 0.33 g), NMR 1.5(s,9H), 3.6(s,6H), 3.8(s,6H), 6.4(d,2H), 7.0(t,1H), 7.2(s,2H).

By proceeding in a similar manner the following compounds were also prepared:

methyl 2-[2-tert-butoxycarbonyl-3-(4,6-dimethoxypyrimidin-2-yl)oxyphenoxy]-3-methoxypropenoate (compound 12), NMR 1.3(s,9H), 3.6(s,3H), 3.8(s,6H), 3.8(s,3H), 5.7(s,1H), 6.7(d,1H), 6.8(d,1H), 7.2(s,1H), 7.2(s,1H); and

methyl 2-[2-tert-butoxycarbonyl-3-(phenylthio)phenoxy]-3-methoxypropenoate (compound 27).

### EXAMPLE 3

A mixture of 2,6-bis(2-methoxy-1-methoxycarbonyl-vinyloxy)benzoic acid (33 mg), potassium carbonate (13 mg) and propargyl bromide (12 microlitres) was stirred and heated in acetonitrile at 70° C. for 5 hours and cooled. Water and ethyl acetate were added and the organic phase dried (magnesium sulphate), evaporated to give propargyl 2,6-bis(2-methoxy-1-methoxycarbonyl-vinyloxy)benzoate (compound 13, 15 mg), MS M+1=421.

By proceeding in a similar manner the following compounds were also prepared:

benzyl 2,6-bis(2-methoxy-1-methoxycarbonyl-vinyloxy)benzoate (compound 14), MS M+1=473; and

propyl 2,6-bis(2-methoxy-1-methoxycarbonyl-vinyloxy)benzoate (compound 15), MS M+1=425.

### EXAMPLE 4

Hydrochloric acid (2M) was added dropwise during 0.25 hour at 0-5° C. to a stirred solution of tert butyl 2,6-bis(2-dimethylamino-1-methoxycarbonyl-vinyloxy)benzoate (1.0 g) in tetrahydrofuran. After 0.5 hour the mixture was stirred at 20° C. for 2 hours, added to brine and extracted with ether. The organic layer was dried (magnesium sulphate), and evaporated to give tert butyl 2,6-bis(2-hydroxy-1-methoxycarbonyl-vinyloxy)benzoate (compound 31, 0.73 g), NMR 1.6(s,9H), 3.7(s,6H), 6.6(d,2H), 7.2(t,1H), 7.4(bs,2H).

By proceeding in a similar manner the following compounds were also prepared:

methyl 2-[2-tert-butoxycarbonyl-3-(4,6-dimethoxypyrimidin-2-yl)oxyphenoxy]-3-hydroxypropenoate (compound 32); and

methyl 2-(2-tert-butoxycarbonyl-3-phenylthiophenoxy)-3-hydroxypropenoate (compound 30).

### EXAMPLE 5

A mixture of methyl 2-(3-bromomethyl-2-tert-butoxycarbonylphenoxy)-3-methoxypropenoate (0.044 g), phenol (0.011 g), potassium carbonate (0.044 g) and potassium iodide (2 crystals) in acetonitrile was heated at 60° C. overnight. After evaporation the residue was dissolved in etherwater and the organic phase washed (water), dried (magnesium sulphate), evaporated and purified by chromatography on silica gel eluting with ethyl acetate/hexane (1:9) to give methyl 2-(2-tert-butoxycarbonyl-3-phenoxymethylphenoxy)-3-methoxypropenoate (compound 35, 0.032 g).

By proceeding in a similar manner the following compounds were also prepared:

methyl 2-[2-tert-butoxycarbonyl-3-(4-chlorophenoxymethyl) phenoxy]-3-methoxypropenoate (compound 36);

methyl 2-[2-tert-butoxycarbonyl-3-(4-cyanophenoxymethyl)phenoxy]-3-methoxypropenoate (compound 37);

methyl 2-[2-tert-butoxycarbonyl-3-(4-methoxyphenoxymethyl)phenoxy]-3-methoxypropenoate (compound 38); and

methyl 2-[2-tert-butoxycarbonyl-3-(4-methylphenoxymethyl)phenoxy]-3-methoxypropenoate (compound 39).

### EXAMPLE 6

A mixture of methyl 2-(2-tert-butoxycarbonyl-3-phenylthiophenoxy)-3-methoxypropenoate (0.845 g) and 3-chloroperbenzoic acid (0.53 g of 70%) was stirred in dichloromethane for 2 hours, washed with sodium bicarbonate solution then water, dried (magnesium sulphate), evaporated and purified by chromatography on silica gel eluting with dichloromethane to give methyl 2-(2-tert-butoxycarbonyl-3-phenylsulphinylphenoxy)-3-methoxypropenoate (0.227 g, compound 28); and methyl 2-(2-tert-butoxycarbonyl-3-phenylsulphonylphenoxy)-3-methoxypropenoate (compound 29, 0.3 g).

### Reference Example 1

A mixture of methyl 2-(4-bromomethyl-2-tert-butoxycarbonyl-3-methylphenoxy)-3-methoxypropenoate (65mg), sodium acetate (14 mg) and N,N-dimethylacetamide was stirred at 70° C. for 5 hours, cooled and diluted with ether and water. The organic phase was washed (water), dried (magnesium sulphate) and evaporated to give methyl 2-(4-acetoxymethyl-2-tert-butoxycarbonyl-3-methylphenoxy)-3-methoxypropenoate (65mg).

By proceeding in a similar manner the following compounds were also prepared:

methyl 2-(3-acetoxymethyl-2-tert-butoxycarbonylphenoxy)-3-methoxypropenoate, NMR 1.6(s,9H), 2.1(s,3H), 3.7(s,3H), 3.8(s,3H), 5.2(s,2H), 6.8(d,1H), 7.0(d,1H), 7.2(t,1H), 7.3(s,1H);

methyl 2-(3-benzoyloxymethyl-2-tert-butoxycarbonyl-4-fluorophenoxy)-3-methoxypropenoate, NMR 1.4(s,9H), 3.6(s,3H), 3.8(s,3H), 5.4(s,2H), 6.7(m,1H), 6.9(t,1H), 7.2(s,1H), 7.3(t,2H), 7.5(t,1H), 8.0(d,2H);

methyl 2-(3-acetoxymethyl-2-tert-butoxycarbonyl-4-chlorophenoxy)-3-methoxypropenoate, NMR 1.5(s,9H), 2.0(s,3H), 3.6(s,3H), 3.8(s,3H), 5.2(s,2H), 6.7(d,1H), 7.2(d,1H), 7.2(s,1H);

methyl 2-(2-tert-butoxycarbonyl-3-phenylacetoxymethyl-4-fluorophenoxy)-3-methoxypropenoate; and

methyl 2-(3-acetoxymethyl-2-tert-butoxycarbonyl-4-fluorophenoxy)-3-methoxypropenoate, NMR 1.5(s,9H), 2.0(s,3H), 3.6(s,3H), 3.8(s,3H), 5.1(s,2H), 6.7(m,1H), 6.9(t,1H), 7.2(s,1H).

### Reference Example 2

A mixture of methyl 2-(3-bromomethyl-2-tert-butoxycarbonyl-4-chlorophenoxy)-3-methoxypropenoate (0.3 g), sodium thiomethoxide (72 mg) and potassium carbonate (0.143 g) was heated in acetonitrile for 4 hours at 70° C. Water and ethyl acetate were added and the organic phase dried (magnesium sulphate), evaporated and purified by chromatography on silica gel eluting with c-hexane/ethyl acetate to give methyl 2-(2-tert-butoxycarbonyl-4-chloro-3-methylthiomethylphenoxy)-3-methoxypropenoate (0.18 g).

By proceeding in a similar manner the following compounds were also prepared:

methyl 2-[2-tert-butoxycarbonyl-3-(methylthiomethyl)phenoxy]-3-methoxypropenoate; and

methyl 2-[2-tert-butoxycarbonyl-4-fluoro-3-phenylthiomethylphenoxy]-3-methoxypropenoate.

### Reference Example 3

There was prepared according to the method of Example 4:

methyl 2-[2-tert-butoxycarbonyl-3-(3-chlorobenzyloxy)phenoxy]-3-hydroxypropenoate.

By proceeding in a similar manner the following compound was also prepared:

methyl 2-[2-tert-butoxycarbonyl-3-(tert-butyidiphenylsilyloxy)phenoxy]-3-hydroxypropenoate.

### Reference Example 4

A mixture of tert-butyl 2,6-bis(methoxycarbonylmethoxy)benzoate (2.05 g), tert-butoxy bis(dimethylamino)methane (4.77 ml) and toluene was heated for 2 hours at 80° C., then washed with brine. The mixture was acidified to pH6 with hydrochloric acid, and the organic layer dried (magnesium sulphate), evaporated and purified by chromatography on silica gel eluting with hexane/ethyl acetate to give tert-butyl 2,6-bis(2-dimethylamino-1-methoxycarbonyl-vinyloxy)benzoate (1.0 g), NMR 1.5(s,9H), 2.9(s,12H), 3.5(s,6H), 6.4(d,2H), 7.0(t,1H), 7.0(s,2H).

By proceeding in a similar manner the following compounds were also prepared:

methyl 2-[2-tert-butoxycarbonyl-3-(4,6-dimethoxypyrimidin-2-yl)oxyphenoxy]-3-dimethylaminopropenoate;

methyl 2-[2-tert-butoxycarbonyl-3-(phenylthio)phenoxy]-3-dimethylaminopropenoate; and

methyl 2-[2-tert-butoxycarbonyl-3-(tert-butyldiphenylsilyloxy)phenoxy]-3-dimethylaminopropenoate.

### Reference Example 5

A mixture of tert-butyl 2,6-dihydroxybenzoate (10 g), and potassium carbonate (13.13 g) in acetonitrile was heated at 80° C. for 1 hour. Methyl bromoacetate (9.8 ml) was added dropwise and the mixture heated at reflux for 10 hours. The mixture was cooled, filtered, evaporated and purified by chromatography on silica gel eluting with hexane/ethyl acetate to give tert-butyl 2,6-bis(methoxycarbonylmethoxy)benzoate (5.8 g), NMR 1.6(s,9H), 3.8(s,6H), 4.6(s,4H), 6.5(d,2H), 7.2(t,1H).

By proceeding in a similar manner the following compounds were also prepared:

tert-butyl 2-(4,6-dimethoxypyrimidin-2-yl)oxy-6-methoxycarbonylmethoxybenzoate;

tert-butyl 2-methoxycarbonylmethoxy-6-phenylthio)benzoate;

tert-butyl 2-tert-butyidiphenylsilyloxy-6-methoxycarbonylmethoxybenzoate; and

methyl 2-[2-tert butoxycarbonyl-3-(3-chlorobenzyloxy)phenoxy]-3-hydroxypropenoate which was prepared from methyl 2-(2-tert butoxycarbonyl-3-hydroxyphenoxy)-3-hydroxypropenoate.

### Reference Example 6

Sodium tert-butoxide (1.79 g) was added to a mixture of 5-(4,6-dimethoxypyrimidin-2-yl)oxy-2,2-dimethyl-4-oxo-benzo-1,4-dioxin (2.06 g) in tert-butanol and stirred at reflux for 3 hours. The cooled mixture was added to ice/water, extracted (dichloromethane), washed (water), dried (magnesium sulphate) and evaporated to give tert-butyl 6-[(4,6-dimethoxypyrimidin-2-yl)oxy]salicylate (0.46 g).

By proceeding in a similar manner the following compound was also prepared: tert-butyl 6-(tert-butyldiphenylsilyloxy)salicylate.

### Reference Example 7

A solution of 2,2-dimethyl-5-hydroxy-4-oxo-benzo-1,3-dioxin (8.0 g) in tetrahydrofuran was added dropwise during 0.25 hour to a stirred suspension of sodium hydride (1.75 g of 60%) under nitrogen. After 0.25 hour 4,6-dimethoxy-2-methylsulphonylpyrimidine (9.68 g) was added during 5 minutes and the mixture heated at reflux overnight. The cooled mixture was diluted with water, extracted (ether), dried (magnesium sulphate), evaporated and purified by chromatography on silica gel eluting with isohexane/ethyl acetate to give 5-(4,6-dimethoxypyrimidin-2-yl)oxy-2,2-dimethyl-4-oxo-benzo-1,3-dioxin (2.64 g).

### Reference Example 8

2-Hydroxy-6-phenylthiobenzoic acid (3.8 g) then tert-butanol (5.8 g) were added to a stirred mixture of magnesium sulphate (7.6 g) and sulphuric acid (0.8 ml) in dichloromethane. After 4 days sodium carbonate solution was added and the organic phase washed with brine, dried (magnesium sulphate) and evaporated to give tert-butyl 2-hydroxy-6-phenylthiobenzoate (3.09).

### Reference Example 9

A solution of boron tribromide (1.4 ml) in dichloromethane was added dropwise during 0.5 hour to a stirred solution of 2-methoxy-6-phenylthiobenzoic acid (4.1 g) under an inert atmosphere at −70° C. After a further 0.5 hour the solution was allowed to warm to ambient temperature, diluted with water and extracted (ethyl acetate). The organic phase washed with brine, dried (magnesium sulphate) and evaporated to give 2-hydroxy-6-phenylthiobenzoic acid (4.0 g).

### Reference Example 10

Sec-butyl lithium (127.5 ml of a 1.3M solution in cyclohexane) was added during 0.5 hour at −70° C. to a stirred solution of N,N,N′,N′-tetramethylethylenediamine (25 ml) in tetrahydrofuran. After a further 1 hour, a solution of 2-methoxybenzoic acid (7.61 g) in tetrahydrofuran was added during 0.5 hour and stirring continued for 2 hours at −70° C. A solution of phenyldisulphide (21.8 g) in tetrahydrofuran was added during 0.5 hour and the mixture allowed to warm to ambient temperature overnight. Water was dded and the aqueous phase washed with ether, acidified (hydrochloric acid), extracted (ethyl acetate), washed (water), dried (magnesium sulphate) and evaporated to give (after trituration with cyclohexane) 2-methoxy-6-phenylthiobenzoic acid (4.1 g).

### Reference Example 11

A mixture of methyl 2-[2-tert-butoxycarbonyl-3-(tert-butyidiphenylsilyloxy)phenoxy]-3methoxypropenoate (2.66 g) and tetrabutylammonium fluoride (5.63 ml of a 1 M solution in tetrahydrofuran) in tetrahydrofuran was stirred for 2 hours at 20° C. under an inert atmosphere. Ethyl acetate and ice/water were added and the organic phase washed (brine), dried (magnesium sulphate) and evaporated to give methyl 2-(2-tert-butoxycarbonyl-3-hydroxyphenoxy)-3-methoxypropenoate (2.77 g).

### Reference Example 12

According to the method of Example 2 there was prepared:

methyl 2-[2-tert-butoxycarbonyl-3-(tert-butyldiphenylsilyloxy)phenoxy]-3methoxypropenoate; and

methyl 2-[2-tert-butoxycarbonyl-3-(3-chlorobenzyloxy)phenoxy]-3-methoxypropenoate.

### Reference Example 13

A solution of 2,2-dimethyl-5-hydroxy-4-oxobenzo-1,3-dioxin (31.3 g) in N,N-dimethylformamide was added to imidazole (25.3 g) and stirred under an inert atmosphere. Tert-butyidiphenylsilyl chloride (46.6 g) was added dropwise and the mixture stirred at 20° C. for 2 days, then added to water and extracted (ether), washed (water and brine), dried (magnesium sulphate) and evaporated to give 2,2-dimethyl-5-tert-butyidiphenylsilyloxy-4-oxobenzo-1,3-dioxin (71.2 g).

According to a feature of the present invention, there is provided a method for controlling the growth of weeds(i.e. undesired vegetation) at a locus, which method comprises applying thereto a herbicidally effective amount of at least one compound of the invention as defined above. For this purpose, the said compound is normally used in the form of a herbicidal composition (i.e. in association with compatible diluents or carriers and/or surface active agents suitable for use in herbicidal compositions), for example as hereinafter described.

The compounds of the invention show herbicidal activity against dicotyledonous (i.e. broad-leafed) and monocotyledonous (e.g. grass) weeds by pre- and/or post-emergence application.

By the term “pre-emergence application” is meant application to the soil in which the weed seeds or seedlings are present before emergence of the weeds above the surface of the soil. By the term “post-emergence application” is meant application to the aerial or exposed portions of the weeds which have emerged above the surface of the soil. For example, the compounds of formula (I) may be used to control the growth Of:

broad-leafed weeds, for example, Abutilon theoPhrasti, Amaranthus retroflexus, Bidens pilosa, Chenorodium album, Galium aiarine, Ipomoea spp. e.g. Ipomoea purpurea, Sesbania exaltata, Sinapis arvensis, Solanum nigrum and Xanthium strumarium, and

grass weeds, for example Alopecurus myosuroides, Avena fatua, Digitaria sanquinalis, Echinochloa crus-galli, Eleusine indica and Setaria spp, e.g. Setaria faberii or Setaria viridis, and sedges, for example, Cyperus esculentus.

The amount of the compound of the invention to be applied varies with the nature of the weeds, the compositions used, the time of application, the climatic and edaphic conditions and (when used to control the growth of weeds in crop-growing areas) the nature of the crops. When applied to a crop-growing area, the rate of application should be sufficient to control the growth of weeds without causing substantial permanent damage to the crop. In general, taking these factors into account, application rates between 1 g and 2000 g of active material per hectare give good results. However, it is to be understood that higher or lower application rates may be used, depending upon the particular problem of weed control encountered.

The compounds of the invention may be used to control selectively the growth of weeds, for example to control the growth of those species hereinbefore mentioned, by pre- or post-emergence application in a directional or non-directional fashion, e.g. by directional or non-directional spraying, to a locus of weed infestation which is an area used, or to be used, for growing crops, for example cereals, e.g. wheat, barley, oats, maize and rice, soya beans, field and dwarf beans, peas, lucerne, cotton, peanuts, flax, onions, carrots, cabbage, oilseed rape, sunflower, sugar beet, and permanent or sown grassland before or after sowing of the crop or before or after emergence of the crop. For the selective control of weeds at a locus of weed infestation which is an area used, or to be used, for growing of crops, e.g. the crops hereinbefore mentioned, application rates from 10 g to 1000 g, and preferably from 25 g to 250 g, of active material per hectare are particularly suitable.

The compounds of the invention may also be used to control the growth of weeds, especially those indicated above, by pre- or post-emergence application in established orchards and other tree-growing areas, for example forests, woods and parks, and plantations, e.g. sugar cane, oil palm and rubber plantations. For this purpose they may be applied in a directional or non- directional fashion (e.g. by directional or non-directional spraying) to the weeds or to the soil in which they are expected to appear, before or after planting of the trees or plantations at application rates between 50 g and 2000 g, and preferably between 50 g and 1000 g, most preferably between 100 g and 500 g of active material per hectare.

The compounds of the invention may also be used to control the growth of weeds, especially those indicated above, at loci which are not crop-growing areas but in which the control of weeds is nevertheless desirable.

Examples of such non-crop-growing areas include airfields, industrial sites, railways, roadside verges, the verges of rivers, irrigation and other waterways, scrublands and fallow or uncultivated land, in particular where it is desired to control the growth of weeds in order to reduce fire risks. When used for such purposes in which a total herbicidal effect is frequently desired, the active compounds are normally applied at dosage rates higher than those used in crop-growing areas as hereinbefore described. The precise dosage will depend upon the nature of the vegetation treated and the effect sought.

Pre- or post-emergence application, and preferably pre-emergence application, in a directional or non-directional fashion (e.g. by directional or non-directional spraying) at application rates between 50 g and 2000 g, and preferably between 50 g and 1000 g, most preferably between 100 g and 500 g of active material per hectare are particularly suitable for this purpose.

When used to control the growth of weeds by pre-emergence application, the compounds of the invention may be incorporated into the soil in which the weeds are expected to emerge. It will be appreciated that when the compounds of the invention are used to control the growth of weeds by post-emergence application, i.e. by application to the aerial or exposed portions of emerged weeds, the compounds of the invention will also normally come into contact with the soil and may also then exercise a pre-emergence control on later-germinating weeds in the soil.

Where especially prolonged weed control is required, the application of the compounds of the invention may be repeated if required.

According to a further feature of the present invention, there are provided compositions suitable for herbicidal use comprising one or more compounds of the invention as defined above in association with, and preferably homogeneously dispersed in, one or more compatible agriculturally- acceptable diluents or carriers and/or surface active agents [i.e. diluents or carriers and/or surface active agents of the type generally accepted in the art as being suitable for use in herbicidal compositions and which are compatible with compounds of the invention]. The term “homogeneously dispersed” is used to include compositions in which the compounds of formula (I) are dissolved in other components. The term “herbicidal compositions” is used in a broad sense to include not only compositions which are ready for use as herbicides but also concentrates which must be diluted before use. Preferably, the compositions contain from 0.05 to 90% by weight of one or more compounds of the invention as defined above.

The herbicidal compositions may contain both a diluent or carrier and surface-active (e.g. wetting, dispersing, or emulsifying) agent. Surface-active agents which may be present in herbicidal compositions of the present invention may be of the ionic or non-ionic types, for example sulphoricinoleates, quaternary ammonium derivatives, products based on condensates of ethylene oxide with alkyl and polyaryl phenols, e.g. nonyl- or octyl-phenols, or carboxylic acid esters of anhydrosorbitols which have been rendered soluble by etherification of the free hydroxy groups by condensation with ethylene oxide, alkali and alkaline earth metal salts of sulphuric acid esters and sulphonic acids such as dinonyl- and dioctyl-sodium sulphonosuccinates and alkali and alkaline earth metal salts of high molecular weight sulphonic acid derivatives such as sodium and calcium lignosulphonates and sodium and calcium alkylbenzene sulphonates.

Suitably, the herbicidal compositions according to the present invention may comprise up to 10% by weight, e.g. from 0.05% to 10% by weight, of surface-active agent but, if desired, herbicidal compositions according to the present invention may comprise higher proportions of surface-active agent, for example up to 15% by weight in liquid emulsifiable suspension concentrates and up to 25% by weight in liquid water soluble concentrates.

Examples of suitable solid diluents or carriers are aluminium silicate, microfine silicon dioxide, talc, chalk, calcined magnesia, kieselguhr, tricalcium phosphate, powdered cork, adsorbent carbon black and clays such as kaolin and bentonite. The solid compositions (which may take the form of dusts, granules or wettable powders) are preferably prepared by grinding the compounds of formula (I) with solid diluents or by impregnating the solid diluents or carriers with solutions of the compounds of the invention in volatile solvents, evaporating the solvents and, if necessary, grinding the products so as to obtain powders. Granular formulations may be prepared by absorbing the compounds of the invention (dissolved in suitable solvents, which may, if desired, be volatile) onto the solid diluents or carriers in granular form and, if desired, evaporating the solvents, or by granulating compositions in powder form obtained as described above. Solid herbicidal compositions, particularly wettable powders and granules, may contain wetting or dispersing agents (for example of the types described above), which may also, when solid, serve as diluents or carriers. Liquid compositions according to the invention may take the form of aqueous, organic or aqueous-organic solutions, suspensions and emulsions which may incorporate a surface-active agent. Suitable liquid diluents for incorporation in the liquid compositions include water, glycols, glycol ethers, tetrahydrofurfuryl alcohol, acetophenone, cyclohexanone, isophorone, N-alkyl pyrrolidones, toluene, xylene, mineral, animal and vegetable oils, esterified vegetable oils and light aromatic and naphthenic fractions of petroleum (and mixtures of these diluents). Surface-active agents, which may be present in the liquid compositions, may be ionic or non-ionic (for example of the types described above) and may, when liquid, also serve as diluents or carriers.

Powders, dispersible granules and liquid compositions in the form of concentrates may be diluted with water or other suitable diluents, for example mineral or vegetable oils, particularly in the case of liquid concentrates in which the diluent or carrier is an oil, to give compositions ready for use.

When desired, liquid compositions of the compound of the invention may be used in the form of self-emulsifying concentrates containing the active substances dissolved in the emulsifying agents or in solvents containing emulsifying agents compatible with the active substances, the simple addition of such concentrates to water producing compositions ready for use.

Liquid concentrates in which the diluent or carrier is an oil may be used without further dilution using the electrostatic spray technique.

Herbicidal compositions according to the present invention may also contain, if desired, conventional adjuvants such as adhesives, protective colloids, thickeners, penetrating agents, spreading agents, stabilisers, sequestering agents, anti-caking agents, colouring agents and corrosion inhibitors. These adjuvants may also serve as carriers or diluents.

Unless otherwise specified, the following percentages are by weight. Preferred herbicidal compositions according to the present invention are aqueous suspension concentrates which comprise from 10 to 70% of one or more compounds of the invention, from 2 to 10% of surface-active agent, from 0.1 to 5% of thickener and from 15 to 87.9% of water;

wettable powders which comprise from 10 to 90% of one or more compounds of the invention, from 2 to 10% of surface-active agent and from 8 to 88% of solid diluent or carrier;

water soluble or water dispersible powders which comprise from 10 to 90% of one or more compounds of the invention, from 2 to 40% of sodium carbonate and from 0 to 88% of solid diluent;

liquid water soluble concentrates which comprise from 5 to 50%, e.g. 10 to 30%, of one or more compounds of the invention, from 0 to 25% of surface-active agent and from 10 to 90%, e.g. 45 to 85%, of water miscible solvent, e.g. triethylene glycol, or a mixture of water-miscible solvent and water;

liquid emulsifiable suspension concentrates which comprise from 10 to 70% of one or more compounds of the invention, from 5 to 15% of surface-active agent, from 0.1 to 5% of thickener and from 10 to 84.9% of organic solvent, e.g. mineral oil;

water dispersible granules which comprise from 1 to 90%, e.g. 25 to 75% of one or more compounds of the invention, from 1 to 15%, e.g. 2 to 10%, of surface-active agent and from 5 to 95%, e.g. 20 to 60%, of solid diluent, e.g. clay, granulated with the addition of water to form a paste and then dried and,

emulsifiable concentrates which comprise 0.05 to 90%, and preferably from 1 to 60% of one or more compounds of the invention, from 0.01 to 10%, and preferably from 1 to 10%, of surface-active agent and from 9.99 to 99.94%, and preferably from 39 to 98.99%, of organic solvent.

Herbicidal compositions according to the present invention may also comprise the compounds of the invention in association with, and preferably homogeneously dispersed in, one or more other pesticidally active compounds and, if desired, one or more compatible pesticidally acceptable diluents or carriers, surface-active agents and conventional adjuvants as hereinbefore described.

Examples of other pesticidally active compounds which may be included in, or used in conjunction with, the herbicidal compositions of the present invention include herbicides, for example to increase the range of weed species controlled for example alachlor [2-chloro-2,6′-diethyl-N-(methoxy-methyl)-acetanilide], atrazine [2-chloro-4-ethylamino-6-isopropylamino-1,3,5-triazine], bromoxynil [3,5-dibromo-4-hydroxybenzonitrile], chlortoluron [N′-(3-chloro-4-methylphenyl)-N,N-dimethylurea], cyanazine [2-chloro-4-(1-cyano-1-methylethylamino)-6-ethylamino-1,3,5-triazine], 2,4-D [2,4-dichlorophenoxy-acetic acid], dicamba [3,6-dichloro-2-methoxybenzoic acid], difenzoquat [1,2-dimethyl-3,5-diphenyl-pyrazolium salts], flampropmethyl [methyl N-2-(N-benzoyl-3-chloro-4-fluoroanilino)-propionate], fluometuron [N′-(3-trifluoro-methylphenyl)-N,N-dimethylurea], isoproturon [N′-(4-isopropylphenyl)-N,N-dimethylurea], insecticides, e.g. synthetic pyrethroids, e.g. permethrin and cypermethrin, and fungicides, e.g. carbamates, e.g. methyl N-(1-butyl-carbamoyl-benzimidazol-2-yl)carbamate, and triazoles e.g. 1-(4-chloro-phenoxy)-3,3-dimethyl-1-(1,2,4-triazol-1-yl)-butan-2-one.

Pesticidally active compounds and other biologically active materials which may be included in, or used in conjunction with, the herbicidal compositions of the present invention, for example those hereinbefore mentioned, and which are acids, may, if desired, be utilized in the form of conventional derivatives, for example alkali metal and amine salts and esters.

The following Examples illustrate herbicidal compositions according to the present invention. The following trade marks appear in the Examples: Synperonic, Solvesso, Arylan, Arkopon, Sopropon, Tixosil, Soprophor, Attagel, Rhodorsil. The Active Ingredient listed in the following examples refers to derivatives of compounds of the invention.

### Example C1

| An emulsifiable concentrate is formed from: | | |
|---|---|---|
| Active Ingredient | 20% | w/v |
| N-Methylpyrrolidinone (NMP) | 25% | w/v |
| Calcium dodecylbenzenesulphonate | 70% | |
| (CaDDBS) (Arylan CA) | 4% | w/v |
| Nonylphenol ethylene oxide propylene oxide | 6% | w/v |
| condensate (NPEOPO) (Synperonic NPE 1800) | | |

| | |
|---|---|
| Aromatic solvent (Solvesso) | to 100 volumes |

by stirring NMP, active ingredient (Compound 1), CaDDBS, NPEOPO and Aromatic solvent until a clear solution is formed, and adjusting to volume with Aromatic solvent.

### Example C2

| A wettable powder is formed from: | | |
|---|---|---|
| Active Ingredient | 50% | w/w |
| Sodium dodecylbenzenesulphonate | 3% | w/w |
| (Arylan SX85) | | |
| Sodium methyl oleoyl taurate | 5% | w/w |
| (Arkopon T) | | |
| Sodium polycarboxylate (Sopropon T36) | 1% | w/w |
| Microfine silicon dioxide (Tixosil 38) | 3% | w/w |
| China clay | 38% | w/w |

by blending the above ingredients together and grinding the mixture in an air jet mill.

### Example C3

| A suspension concentrate is formed from: | | |
|---|---|---|
| Active Ingredient | 50% | w/v |
| Antifreeze (Propylene glycol) | 5% | w/v |
| Ethoxylated tristyrylphenol phosphate | 0.5% | w/v |
| (Soprophor FL) | | |
| Nonyl phenol 9 mole ethoxylate | 0.5% | w/v |
| (Ethylan BCP) | | |
| Sodium polycarboxylate (Sopropon T36) | 0.2% | w/v |
| Attaclay (Attagel) | 1.5% | w/v |
| Antifoam (Rhodorsil AF426R) | 0.003% | w/v |

| | |
|---|---|
| Water | to 100 volumes |

by stirring the above ingredients together and milling in a bead mill.

### Example C4

| A water dispersible granule is formed from: | | |
|---|---|---|
| Active Ingredient | 50% | w/w |
| Sodium dodecylbenzenesulphonate | 3% | w/w |
| (Arylan SX 85) | | |
| Sodium methyl oleoyl taurate (Arkopon T) | 5% | w/w |
| Sodium polycarboxylate (Sopropon T36) | 1% | w/w |
| Binder (Sodium lignosulphonate) | 8% | w/w |
| China clay | 30% | w/w |
| Microfine silicon dioxide (Tixosil 38) | 3% | w/w |

by blending the above ingredients together, grinding the mixture in an air jet mill and granulating by addition of water in a suitable granulation plant (e.g. Fluid bed drier) and drying. Optionally the active ingredient may be ground either on its own or admixed with some or all of the other ingredients.

The following non-limiting examples illustrate the invention.

### Experimental Example 1

Seed of various broad-leaf and grass weed species were sown and herbicide, dissolved in a mixture of acetone and water, was applied at a rate of 250 g/ha to the soil surface. The said weeds are Amaranthus retroflexus, Abutilon theophrasti, Galium aparine, Ipomoea purpurea, Setaria viridis, Alopecurus myosuroides, Avena fatua and Echinochloa crus-calli.

Two weeks after treatment the percentage reduction in plant growth was assessed in comparison with an untreated control.

### Experimental Example 2

Seed of the various weed species, as listed in experimental example 1, were sown and grown up to a 1-3 leaves stage. A post-emergence application of herbicide, dissolved in a mixture of acetone and water, was applied at a rate of 250 g/ha or less. Two weeks after treatment the percentage reduction in plant growth was assessed, in comparison with an untreated control.

### Experimental Example 3

Compounds of the invention were assessed in a similar test as Experimental Example 1 but which employed the following weed species: Amaranthus retroflexus, Abutilon theophrasti, Setaria viridis, Alopecurus myosuroides, Avena fatua, Chenopodium album, Lamium purpureum, Lolium multiflorum, Matricaria inodora, Poa annua, Polygonum convolvulus and Stellaria media.

### Experimental Example 4

Compounds of the invention were assessed in a similar test as Example 2 in which the weed species were as in Example 3.

Compounds 1, 2, 4-11, 13, 16 and 19 gave at least 80% reduction in the growth of one or more weed species in one or both of experimental examples 1 and 2.

Compounds 17, 18 and 20 gave at least 70% reduction in the growth of one or more weed species in one or both of experimental examples 1 and 2.

Compounds 22, 23, 24 and 26 gave at least 80% reduction in the growth of one or more weed species in one or both of experimental examples 3 and 4.

1. A compound which is aryl vinyl ether of formula (I): 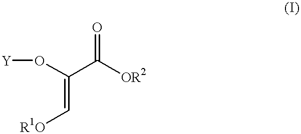
wherein;
R¹ and R², which are the same or different, each independently represent a hydrogen atom, alkyl, alkenyl, alkynyl or —(CH₂)ₘ-phenyl;
Y represents a group of formula (A) or (B); 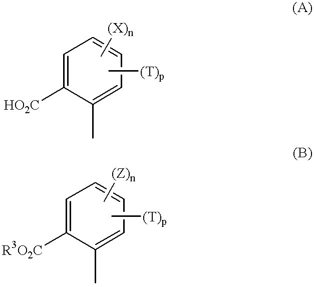
X represents —CH₂OCOR⁴, —CH₂S(O)_{q}R⁵, —CH₂S(O)_{q}R¹⁶, —CH₂CN, —CH₂CO₂R⁶, —CH₂OR⁷ or a group Z;
Z represents —OC(CO₂R⁸)═CHOR⁹, —OR¹⁰, —CH2NHCOR¹¹, —CH₂SCOR¹², —CH₂OC(═S)R¹², —CH₂SC(═S)R¹², —S(O)ₜR¹⁵, —CH₂CH₂R¹⁶, —CH₂SO₂NR^{a}R^{b}, —CH₂OR¹⁶, —OCH₂R¹⁶, or a group of formula (C); 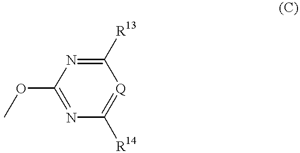
R³ represents alkyl, haloalkyl, alkenyl, haloalkenyl, alkynyl, haloalkynyl or —CH₂COR¹⁶;
R⁴ represents alkyl, haloalkyl, alkenyl, haloalkenyl, alkynyl, haloalkynyl, cycloalkyl, cycloalkylalkyl or —(CH₂)ₛR¹⁶;
R⁵, R⁶, R⁷, R¹¹ and R¹² , which are the same or different, independently represent alkyl or haloalkyl;
R⁸ is as defined for R²;
R⁹ is as defined for R¹;
R¹⁰ represents alkenyl, alkynyl, cycloalkyl; or an alkyl or haloalkyl group which is substituted by a group selected from alkoxy, haloalkoxy, alkoxycarbonyl, cyano, carbamoyl, alkylcarbamoyl, dialkylcarbamoyl and R¹⁶;
R¹³ and R¹⁴, which are the same or different, each independently represent alkyl or alkoxy;
R¹⁵ represents R¹⁰ or R¹⁶;
R¹⁶ represents phenyl unsubstituted or substituted by halogen, alkyl, haloalkyl, —S(O)ᵣR¹⁷, cyano, nitro, alkoxy or haloalkoxy;
R^{a} and R^{b}, which are the same or different, each independently represent hydrogen, alkyl or haloalkyl;
Q represents CH or N;
T represents a halogen atom, hydroxy, cyano, alkoxycarbonyl, alkyl, haloalkyl, alkenyl, haloalkenyl, alkynyl, haloalkynyl, cycloalkyl, alkoxy, haloalkoxy, haloalkoxycarbonyl, nitro, amino, alkylamino, dialkylamino, phenoxy, alkylcarbonylamino, carbamoyl, alkylcarbamoyl, dialkylcarbamoyl or —S(O)ᵣR¹⁷;
R¹⁷ represents alkyl, haloalkyl, alkenyl or haloalkenyl;
m and s represent zero or one;
n represents one or two;
p represents zero, one, two or three;
q, r and t represent zero, one or two;
or an agriculturally acceptable salt or metal complex thereof.

2. A compound according to claim 1 wherein:
R¹ and R², which are the same or different each independently represent a hydrogen atom, alkyl, alkenyl, alkynyl or —(CH₂)ₘ-phenyl;
Y represents a group of formula (A) or (B); 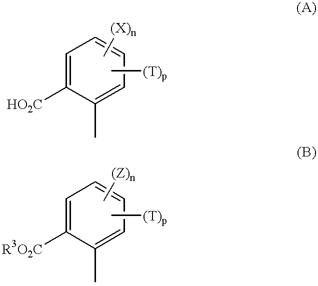
X represents —CH₂OCOR⁴, —CH₂S(O)_{q}R⁵, —CH₂CN, —CH₂CO₂R⁶, —CH₂OR⁷ or a group Z;
Z represents —OC(CO₂R⁸)═CHOR⁹, —OR¹⁰, —CH2NHCOR¹¹, —CH₂SCOR¹², —CH₂OC(═S)R¹², —CH₂SC(═S)R¹², —S(O)ₜR¹⁵ or a group of formula (C); 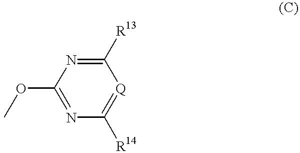
R³ represents alkyl, haloalkyl, alkenyl, haloalkenyl, alkynyl, haloalkynyl or —CH₂COR¹⁶;
R⁴ represents alkyl, haloalkyl, alkenyl, haloalkenyl, alkynyl, haloalkynyl, cycloalkyl, cycloalkylalkyl or —(CH₂)₄R¹⁶;
R⁵, R⁶, R⁷, R¹¹ and R¹², which are the same or different, independently represent alkyl or haloalkyl;
R⁸ is as defined for R²;
R⁹ is as defined for R¹;
R¹⁰ represents alkenyl, alkynyl, cycloalkyl; or an alkyl or haloalkyl group which is substituted by a group selected from alkoxy, haloalkoxy, alkoxycarbonyl, cyano, carbamoyl, alkylcarbamoyl, dialkylcarbamoyl and R¹⁶;
R¹³ and R¹⁴, which are the same or different, each independently represent alkyl or alkoxy;
R¹⁵ represents R¹⁰ or R¹⁶;
R¹⁶ represents phenyl unsubstituted or substituted by halogen, alkyl, haloalkyl, —S(O)ᵣR¹⁷, cyano, nitro, alkoxy or haloalkoxy;
Q represents CH or N;
T represents a halogen atom, hydroxy, cyano, alkoxycarbonyl, alkyl, haloalkyl, alkenyl, haloalkenyl, alkynyl, haloalkynyl, cycloalkyl, alkoxy, haloalkoxy, haloalkoxycarbonyl, nitro, amino, alkylamino, dialkylamino, phenoxy, alkylcarbonylamino, carbamoyl, alkylcarbamoyl, dialkylcarbamoyl or —S(O)ᵣR¹⁷;
R¹⁷ represents alkyl, haloalkyl, alkenyl or haloalkenyl;
m and s represent zero or one;
n represents one or two;
p represents zero, one, two or three;
q, r and t represent zero, one or two;
or an agriculturally acceptable salt or metal complex thereof.

3. A compound according to claim 1 in which R¹ represents hydrogen, alkyl or propargyl.

4. A compound according to claim 1, 2 or 3 in which R² represents alkyl.

5. A compound according to any one of the preceding claims in which one X group is present which is located ortho to the CO₂H group (when Y is a group of formula (A)), or one Z group is present which is located ortho to CO₂R³ (when Y is a group of formula (B)).

6. A compound according to claim 1 or any one of claims 3 to 5 in which Y represents a group of formula (A) and X represents —CH₂OCOR⁴; —CH₂S(O)_{q}R⁵; —CH₂OR⁷; —OC(CO₂R⁸)═CHOR⁹; —CH₂S(O)_{q}R¹⁸ where R¹⁶ is phenyl; —S(O)ₜR¹⁵ where R¹⁵ is phenyl; —CH₂OR¹⁶ where R¹⁶ is phenyl optionally substituted by halogen, CN, alkoxy or alkyl; —OCH₂R¹⁶ where R¹⁶ is phenyl optionally substituted by halogen; or a group of formula (C);
R⁴ represents alkyl or —(CH₂)ₛR¹⁶ where R¹⁶ represents phenyl;
R⁵, R⁷, R⁸ and R⁹each represent alkyl;
R¹³ and R¹⁴ represent methyl or methoxy; and
Q represents CH.

7. A compound according to claim 1 or any one of claims 3 to 6 in which Y represents a group of formula (B) and Z represents —OC(CO₂R⁸)═CHOR⁹; —S(O)ₜR¹⁵ where R¹⁵ is phenyl; —CH₂OR¹⁶ where R¹⁶ is phenyl optionally substituted by halogen, CN, alkoxy or alkyl; or a group of formula (C);
R⁸ and R⁹ each represent alkyl;
R¹³ and R¹⁴ represent methyl or methoxy; and
Q represents CH.

8. A compound according to claim 1 or any one of claims 3 to 7 in which:
R¹ represents hydrogen, methyl or propargyl;
R² represents methyl;
Y represents a group of formula (A);
X represents —CH₂OCOR⁴; —CH₂S(O)_{q}R⁵; —CH₂OR⁷; —OC(CO₂R⁸)═CHOR⁹; —CH₂S(O)_{q}R¹⁶ where R¹⁶ is phenyl; —CH₂OR¹⁶ where R¹⁶ is phenyl optionally substituted by halogen, CN, alkoxy or alkyl; —OCH₂R¹⁶ where R¹⁶ is phenyl optionally substituted by halogen; or a group of formula (C);
R⁴ represents alkyl or —(CH₂)ₛR¹⁶ where R¹⁶ represents phenyl;
R⁵, R⁷, R⁸ and R⁹each represent alkyl;
R¹³ and R¹⁴ represent methyl or methoxy;
Q represents CH; and
T represents halogen or alkyl.

9. A compound according to any one of the preceding claims in which R¹ represents methyl or propargyl; R² represents methyl; Y represents a group of formula (B) and Z represents —OC(CO₂R⁸)═CHOR⁹ or a group of formula (C);
R⁴ represents alkyl or —(CH₂)ₛR¹³;
R⁸ and R⁹ each represent alkyl;
R¹³ and R¹⁴ represent methyl or methoxy;
R¹⁶ represents phenyl;
Q represents CH; and
T represents halogen or alkyl.

10. A herbicidal composition comprising an effective amount of a compound as defined in any one of the preceding claims in association with an agriculturally acceptable diluent or carrier and/or surface active agent.

11. A method for the control of weeds at a locus which comprises applying thereto an effective amount of a compound as defined in any one of claims 1 to 9 or a herbicidal composition as defined in claim 10.

12. A method according to claim 11 wherein the locus is an area used, or to be used, for the growing of crops and the said compound is applied thereto at an application rate of from 10 g to 1000 g/ha.

13. A process for the preparation of a compound as defined in claim 1, which process comprises:
(a) where Y represents a group of formula (A), hydrolysing a corresponding compound in which the —CO₂H group is replaced by —CO₂R³ wherein R³ is tert-butyl; or
b) where R¹ is alkyl, alkenyl, alkynyl or —(CH₂)ₛphenyl, alkylating a corresponding compound of formula (I) wherein R¹ is hydrogen; or
c) where R¹ is hydrogen, aminomethylating a compound of formula (II): 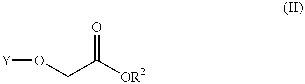
wherein R² is as defined in claim 1, followed by acid hydrolysis; or
(d) where Y represents a group of formula (B), esterifying a corresponding compound in which the —CO₂R³ group is replaced by —CO₂H, by treatment with an alcohol of formula (III):
R³—OH (III)
wherein R³ is as defined in claim 1; or with a halide of formula (IIIa):
R³—L (IIIa)
wherein L is a leaving group; or
(e) where Y is a group of formula (A) and X is —CH₂OCOR⁴, treating a corresponding compound in which X is replaced —CH₂—L, wherein L is a leaving group, with a metal salt of formula (IV):
R⁴COO⁻M⁺ (IV)
wherein R⁴ is as defined in claim 1 and M is an alkali metal; or
(f) where Y is a group of formula (A) and X is —CH₂OR⁷, treating a corresponding compound in which X is replaced —CH₂—L, wherein L is a leaving group, with a metal salt of formula (V):
R⁷OM (V)
wherein R⁷ is as defined in claim 1 and M is an alkali metal; or
(g) where Y is a group of formula (A), X is —CH₂S(O)_{q}R⁵ and q is zero, thiolating a corresponding compound in which X is replaced —CH₂—L, wherein L is a leaving group, using a metal salt of formula (VI):
R⁵SM (VI)
wherein R⁵ is as defined in claim 1 and M is an alkali metal; or
(h) where Y is a group of formula (A), X is —CH₂S(O)_{q}R⁵ and q is one or two, oxidising a corresponding compound in which q is zero or one; or
(i) where Y is a group of formula (A) and X is —CH₂CN, cyanating a corresponding compound in which X is replaced by —CH₂—L, wherein L is a leaving group; and
(j) if desired, converting a resulting compound of formula (I) into an agriculturally acceptable salt thereof.
